(19) United States
(12) Patent Application Publication
(10) Pub. No.: US 2005/0091135 A1
(43) Pub. Date: Apr. 28, 2005

(54) System and method for intelligent document generation and printing

(75) Inventor: Susan M. Britton, Georgetown (CA)

Correspondence Address: ICE MILLER, ONE AMERICAN SQUARE, BOX 82001, INDIANAPOLIS, IN, 46282, US

(73) Assignee: ADP Investor Communications Corporation, (a Nova Scotia corporation), Mississauga (CA)

(21) Appl. No.: 10/827,157

(22) Filed: Apr. 19, 2004

Related U.S. Application Data
(60) Provisional application No. 60/512,856, filed on Oct. 22, 2003.

(51) Int. Cl. G06F 17/60

(52) U.S. Cl. 705/35; 705/36

(57) ABSTRACT

A system and method for the creation of a customized investor document for transmission to the investor. In the case of mutual fund purchases, the customized document includes only those of Part A, Part B, Part A notes, and amendments of the then current simplified prospectus required or desired to be provided. The system and method of the present invention also provide for ancillary documents to be provided together with required or desired documents in a single, customized investor document. The present invention is automated and can be used on demand to produce consolidated, personalized investor documents for a myriad of types of transactions.

### RELATED APPLICATIONS

This non-provisional patent application is a continuation-in-part of U.S. provisional patent application Ser. No. 60/512,856, filed Oct. 22, 2003.

### FIELD OF THE INVENTION

The present invention relates generally to the provision of required disclosure information and other communications to investors and/or investor's advisors. More particularly, the present invention relates to an automated system for generating and distributing compliance information and other information to purchasers of mutual funds and equity securities.

### BACKGROUND OF THE INVENTION

Dealers that trade in securities not previously issued are required to provide investors a prospectus under which the securities are issued at the point of sale. The prospectus and other information required by law or regulation to be delivered to an investor are collectively referred to herein as compliance information. The time window in which the dealer has to provide the prospectus is dictated by regulation and is typically before or not later than two business days after a trade. The requirements apply to all mutual fund sales because mutual fund securities are in constant distribution by the mutual fund and, therefore, always sold under a prospectus.

The type of prospectus required for most mutual funds is a simplified prospectus that describes the holdings of the fund and contains other information of the kind and in the form prescribed by regulation. In a simplified prospectus, Part A contains introductory information about the mutual fund, general information about mutual funds, and information applicable to the mutual funds managed by the mutual fund organization. Part B of a simplified prospectus contains specific information about the mutual fund to which the simplified prospectus applies. It is common for a mutual fund manager to offer many mutual funds, often grouped into families. The regulations of many countries, including the U.S. and Canada, permit the consolidation of simplified prospectuses into a multiple simplified prospectus if the Part A sections of the simplified prospectus for each of the mutual funds is substantially similar. A multiple prospectus is then created with the general information common to all funds provided in Part A of the simplified prospectus and each fund individually described in a Part B section. The Part B section for one mutual fund is typically short and often spans less than five pages containing fund specific information including historical performance and fund holdings at a given date. In a multiple simplified prospectus, one Part A section is typically bound together with two or more Part B sections for various individual funds. Fund managers typically use a multiple simplified prospectus to assist accurate compliance with delivery requirements. Amendments are made to the simplified prospectus when there is a significant change with respect to a mutual fund after the prospectus has been filed with the regulators.

When a mutual fund is sold to an investor, the dealer must send confirmation of the trade and a simplified prospectus together with any amendments thereto to the investor. A pre-printed simplified prospectus containing the required information about the fund purchased as well as any other funds described in the same document is usually sent to fulfill the requirement. If the simplified prospectus is contained in the same mailing as the trade confirmation, a manual process of picking the prospectus from an inventory carried by the dealer is performed and the prospectus is then mailed with the trade confirmation. Regulations typically provide that delivery of the prospectus is required unless an investor has already received the prospectus. If there has been a new prospectus or an amendment since the investor last purchased the mutual fund or another mutual fund is purchased, the relevant prospectus or amendment must be sent.

From the perspective of the mutual fund, the production of large printed and bound multiple simplified prospectuses is costly as they must be produced in sufficient volume to allow dealers to provide them to all purchasers of any fund described in the document. From the perspective of the dealer, the prospectuses must be held in inventory for the purposes of fulfilling regulatory requirements. The inventory often requires a large amount of space, and can lead to complex mailing routines to ensure that an investor has received the proper simplified prospectus and any relevant amendments. Further, the mailing costs incurred by the dealer to mail the entire multiple simplified prospectuses, which is often more information than is needed by the investor according to regulations, is a significant expense. For both the mutual fund and the dealer, the production and management of the prospectuses are time and cost intensive.

From the perspective of the investor, a multiple simplified prospectus covering many funds is received with each purchase of a fund in a fund family unless it has been sent before, and is a common source of confusion. Although the Part A is often found to be relevant, unless the investor is familiar with the name of the mutual funds that the investor has purchased, it can be difficult to determine which Part B is relevant. Because mutual funds in a simplified prospectus are in the same fund family, it is common for multiple funds to have similar names, which further complicates the task of finding the Part B related to a particular mutual fund. For these reasons, many investors are confused and do not read the information provided to them.

Some prior art systems have been developed to provide compliance documents, such as a prospectus, to the investor electronically. Examples of such systems include U.S. Publication Nos. 2002/0055898 and 2002/0065896. While these systems may reduce the mailing costs associated with the provision of compliance documents, these systems still provide extraneous information to the investor and do not personalize the information provided according to the investor and the investor's transaction history. Further, because electronic delivery must be explicitly selected by an investor, and often only a small fraction of investors have so elected, the actual cost savings offered by these systems has often been small.

Other prior art systems also provide compliance information electronically. Consider, for example, Japanese Patent Publication Nos. 2002 265928 A2, 2002 366757 A2, and 2003 187079 A2. These systems deal with the provision of an electronic prospectus to a investor—the first discloses a system for sending a prospectus to a customer at the request of the customer prior to the purchase of any security covered by that prospectus; the second discloses provision of a paper prospectus if a purchaser of a security has not downloaded an electronic version of the prospectus within a prescribed period of time; and the third system prohibits a customer from purchasing a security if the customer has not received the prospectus for that security. Such prior art systems are not integrated with a transaction system to ensure provision of all compliance information prior to the purchase of a security.

It is, therefore, desirable to provide a system to provide an investor with a customized document containing only information related to the funds purchased together with any other required or useful and relevant information. Such a system results in provision of a personalized document. It is also desired that the system examines an investor's present and past transaction history for the personalized document. Such a system should also avoid the cost and errors involved in manually assembling such documents (often referred to as the manual “pick-and-pack process”). It is also desired to consolidate several documents for the same investor into a single mailing. Such a single mailing saves significant costs in distribution, whether the mailing is made by postal service or electronically. It is further desired to provide a system that eliminates the cost of printing, sorting, and managing pre-printed inventory.

### SUMMARY OF THE INVENTION

The present invention comprises a system and method for production of an investor document. The present invention is useful for a myriad of transaction types—particularly those where the contents of the investor document are required by law or regulation (based on legal rules) and/or driven by business rules (such as a broker's preference for such content).

In one embodiment of the method of the present invention, a network, electronic document source, and processor are required to be provided. The electronic document source is operatively connected to the network and comprises compliance and/or ancillary documents of the type to be used to create the investor document. The processor is also operatively connected to the network.

After provision of the network, electronic document source, and the processor, the processor retrieves investment information over the network. Next, based on the received investment information, applicable legal and/or business rules are applied to determine at least one required document from at least one part of at least one compliance document. Next, the at least one required document is mapped to the transaction, and the at least one required document is retrieved from the electronic document source. Then, the investor document is produced using the required document based on the mapping.

One embodiment of the system of the present invention includes a network, an electronic document source, and a processor. The processor is programmed to perform the steps according to the method of the present invention.

In one application of the system and method of the present invention, the investor document produced contains the portions of a prospectus required for a mutual fund transaction. The portions required are generally dictated by legal requirements established by regulatory authorities. In another application, the investor document comprises the annual report or semi-annual report of a mutual fund company. In a third application, the investor document comprises a welcome kit of prospectus and other information for a new investor. In yet another application, the investor document comprises prospectus for a securities trade, where the security trade is other than a mutual fund.

The present invention obviates or mitigates at least one disadvantage of previous compliance information transmittal systems. The present invention offers the advantages of automation, consolidation, personalization, and on-demand production. The system and method of the present invention avoids the costs associated with the manual pick-and-pack process. Several documents are consolidated for an investor into a single mailing, thereby reducing costs associated with the mailing. The present invention permits one to create a personal document unique to a specific investor and to that specific investor's present and past trades. This personalization also contributes to reduction in print and mailing costs because extraneous information not required for that investor is not printed or mailed. Further, the system and method of the present invention provides for on-demand production of documents required to be provided to investors, thereby eliminating costs associated with prior art systems and methods arising from printing, sorting, and managing pre-printed inventory.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows a functional flowchart illustrating one embodiment of the method of present invention;

FIG. 2 shows a block diagram illustrating one embodiment of a system of the present invention;

FIG. 3A shows a block diagram of one embodiment of the overall system for automatically generating personalized documents according to the present invention;

FIG. 3B shows a block diagram of another embodiment of the system according to the present invention having an electronic delivery subsystem;

FIG. 4 shows a block diagram of one embodiment of the process of electronic assembly of custom documents according to the present invention;

FIG. 5 shows a block diagram of one embodiment of the process of obtaining compliance documents according to the present invention;

FIG. 6 shows a block diagram of one embodiment of electronically preparing composition data to print on-demand only the custom documents required according to the present invention;

FIG. 7 shows a block diagram of one embodiment of the composition process according to the present invention;

FIG. 8 shows diagram of a one embodiment of a trade confirmation template according to the present invention;

FIG. 9 shows a block diagram of one embodiment of the document segmentation process according to the present invention;

FIG. 10 shows a block diagram of one embodiment of the document conversion process according to the present invention; and

FIG. 11 shows a block diagram of one embodiment of the system of the present invention.

### DETAILED DESCRIPTION

Generally, the present invention provides a method and system for generating and mailing or transmitting customized documents to investors. Each customized document comprises compliance information and is unique to an investor and that investor's present and past transaction history.

The present invention facilitates the delivery of “intelligent” documents, together with a transaction confirmation, either printed on demand (POD) and mailed, or delivered electronically (such as via an e-mail notification with a link to the document) to the investor. This is achieved by printing or electronically delivering only information pertinent to the investor's purchase, having regard to previous information provided to the investor. For example, in the case of mutual fund transactions, only documents relating to the specific mutual fund securities that the individual investor actually purchased are provided.

As will be clear to those of skill in the art, the present invention can be used to prepare and disseminate any custom document(s) that must be provided to an investor. For exemplary purposes, the following discussion describes embodiments of the present invention directed toward the delivery of compliance information related to the purchase of one or more mutual funds. Following this discussion is a broader example of the present invention describing the provision of generic compliance information, such as quarterly reports, for a stock purchase.

One skilled in the art will appreciate that sending an investor information about a purchased security or mutual fund security entails complying with several laws and/or regulations that may differ from jurisdiction to jurisdiction. The present invention provides a mechanism for the custom generation of this compliance information in a manner that allows an investment dealer to provide the investor with only the most up to date required information. In one embodiment of the present invention, a package generated upon the purchase of one or more mutual fund securities contains, all in the investor's language of choice, a cover letter; a trade confirmation for each mutual fund purchase made on the same day though the dealer, consolidated by the appropriate account; a Part A (if required), the relevant Part B section or sections, and all relevant amendments to the simplified prospectus (if necessary). In one embodiment, only information that is relevant to the purchase and has not previously been sent to the investor is included in the compliance information package provided to the investor.

By sending an investor only the information applicable to the investor's mutual fund purchase(s), there results an overall reduction in costs for both the mutual fund and the dealer. There are significantly reduced mailing costs, as only a portion of the entire prospectus is generated, which results in a lower mailing weight. Additionally, a “print on demand” (POD) service is used in one embodiment to consolidate purchases of more than one mutual fund within an account into one mailing, thereby reducing the number of packages being mailed to investors. Further, by only printing documents when needed, the cost required to store and manage pre-printed inventory is also eliminated. The combination of confirmations of purchases with relevant portions of simplified prospectuses permits the number of mailings at the point of sale to be reduced. From the perspective of the mutual fund, there is an elimination, or great reduction, in the cost of commercially printing the prospectus. The present invention also allows the most up-to-date information to be sent to an investor as the information is generated specifically for the investor.

The present invention allows for mailing or delivering simplified (or, where required, preliminary) prospectuses, trade confirmations and other documents to purchasers by dealers and performing any annual and requested or other mailings of preliminary or simplified prospectuses and other related documents on behalf of mutual funds or public companies. The present invention permits dealers, mutual funds and public companies to meet their regulatory obligations and to make other voluntary mailings as may be desired.

To obtain the information required to generate the customized documents, databases such as the U.S. Securities and Exchange Commission's EDGAR and/or the Canadian Depository for Securities SEDAR, are employed, in addition to other public or private sources. These databases contain electronic versions of up to date prospectuses, along with any amendments, and other required disclosure documents. Typically, multiple simplified prospectuses are filed as single documents having a Part A and multiple Part Bs. The database allows a query based on a particular mutual fund, and returns an electronic copy of the simplified prospectus that is associated with the mutual fund.

To deliver only the required information, the system of the present invention uses known techniques to differentiate the Part A from the Part Bs in the simplified prospectus. The identified Part A is then extracted and printed if it is to be sent to the investor. The Part A will preferably be omitted from a mailing if it has already been sent to the investor. The remaining prospectus is then examined and the various Part Bs associated with the different mutual funds are differentiated. In a presently preferred embodiment of the present invention, the consolidated Part Bs section is electronically examined to determine which pages correspond to the mutual fund in question. This can be done using a number of known techniques, including an optical character recognition process on a predefined portion of a page to identify if the page belongs to a particular mutual fund. Upon locating any Part B associated with the purchased mutual fund, any amendment to the simplified prospectus associated with the purchased mutual fund is located through another database search.

One skilled in the art will appreciate that the retrieval of Part B for a particular mutual fund can be done using a database that has previously analyzed a prospectus and determined which pages are related to a given fund. Such a database may provide either page number references, or may have copies of the pages themselves. Additionally, the database containing a retrieved unified prospectuses can also store information associated with a particular fund indicating the start and end points of the relevant Part B. Thus, through the use of databases, it is possible to create a listing, indexed by fund, that provides an indication of where the relevant Part A and Part B for a given fund are located in a combined prospectus. Additionally, funds may cross reference each other in the database to indicate which funds share a common Part A.

According to the present invention, the identified required Part A and Part Bs, any amendments thereto (if any), and other relevant documents (if any) are all printed along with the trade confirmation and any other desired and permitted information, which is then finished, such as being inserted into an envelope or poly-wrapped or shrink-wrapped, and mailed to the investor. In an alternate embodiment for use in circumstances where electronic delivery is desired and is permitted by regulatory authorities, the electronic versions of the same documents are joined together and provided in an electronic message, attached to an electronic trade confirmation that is electronically transmitted to the investor, or made available via a link provided electronically to the investor.

As an example of how the system operates, consider the situation of an investor who purchases securities of two mutual funds offered under a single simplified prospectus that offers 50 mutual funds managed by the same mutual fund manager. The mutual fund manager has, as is most common in the industry, filed all parts of the simplified prospectus in the regulatory database as a single document. Assuming the investor has not already received the Part A of the simplified prospectus, the system and method of the present invention would result in delivery of Part A and only the two Part Bs that describe the two funds actually purchased by the investor. With prior art systems, the dealer would be required to send or deliver the Part A and the Part Bs for all 50 funds at much greater cost and increased risk of the investor being confused and not reading any of the material.

The delivery of the simplified prospectus can be combined with certain other documents required or desired to be delivered. For dealers, the present invention permits transmission of a cover letter, a trade confirmation, and the relevant portions of the prospectus. For mutual funds, the system permits delivery of the relevant portions of the prospectus to investors together with other desired or required documentation. Because the system can be automated to determine which portions of a document are related to the particular mutual fund being purchased, the present invention can be integrated with an automated mailing system to provide delivery or mailing within applicable regulatory time periods.

Systems for tracking the information provided to an investor are known in the art. With the collaboration of these systems, the present invention can maintain a database that indicates accurately the material which a given investor must receive depending on the funds purchased or held and what parts of the current prospectus and applicable amendments the investor has already received. Thus, even the reduced simplified prospectus is not sent to an investor that has already received it.

The implementation of the present invention permits for the provision of meaningful information to an investor at a greatly reduced cost to dealers, mutual funds, and public companies. This reduced cost can be passed on to mutual fund investors in the form of reduced management expense ratios of the mutual funds that they purchase. In addition, the lower inventory and mailing costs incurred by dealers can be passed onto investors by lower commissions or transaction fees.

Currently, when an investor purchases a variety of mutual funds of different fund families managed by different managers at the same time, the required point of sale delivery is accomplished by inserting an entire multiple simplified prospectus for each fund family involved in an envelope with, if applicable, the confirmation of the purchases. The trade confirmation is typically stapled to one of the multiple simplified prospectuses so that it is not lost in the envelope. Market research has indicated that investors find this mailing confusing. Also, the large volume is a disincentive to reading the material. Embodiments of the present invention provide a single booklet that contains, in order, if desired, a cover letter that will identify what the document contains, a confirmation of each purchase, the Part A for the first mutual fund identified on the letter and confirmation, the relevant Part B for the first mutual fund and any applicable amendments, the Part A for the second mutual fund identified on the cover letter and confirmation, the relevant Part B for the second fund and any applicable amendments, and so on. The cover letter preferably identifies, for example, that the document contains a trade confirmation, Mutual Fund #1 simplified prospectus Part A, Mutual Fund #1 simplified prospectus Part B, Mutual Fund #1 amendments to Part A or Part B, Mutual Fund #2 Part A Note, Mutual Fund #2 simplified prospectus Part B, and Mutual Fund #2 amendments to Part A and Part B (assuming that the investor has already received Part A of Mutual Fund #2 simplified prospectus). Preferably, all parts of a simplified prospectus and amendments for one or more funds of each fund family will be together in the document produced by the present invention. Documents with respect to one mutual fund family will not be mixed with and will be clearly distinguished from the documents of any other mutual fund family, but will be bound in the same book.

In one embodiment, each prospectus includes its cover page as available in the database and an introductory cover page that identifies the individual mutual funds in a fund family that are included in the document. When the documentation for one mutual fund is finished, the prospectus of the next fund in the specified order will be identified by that prospectus's cover page.

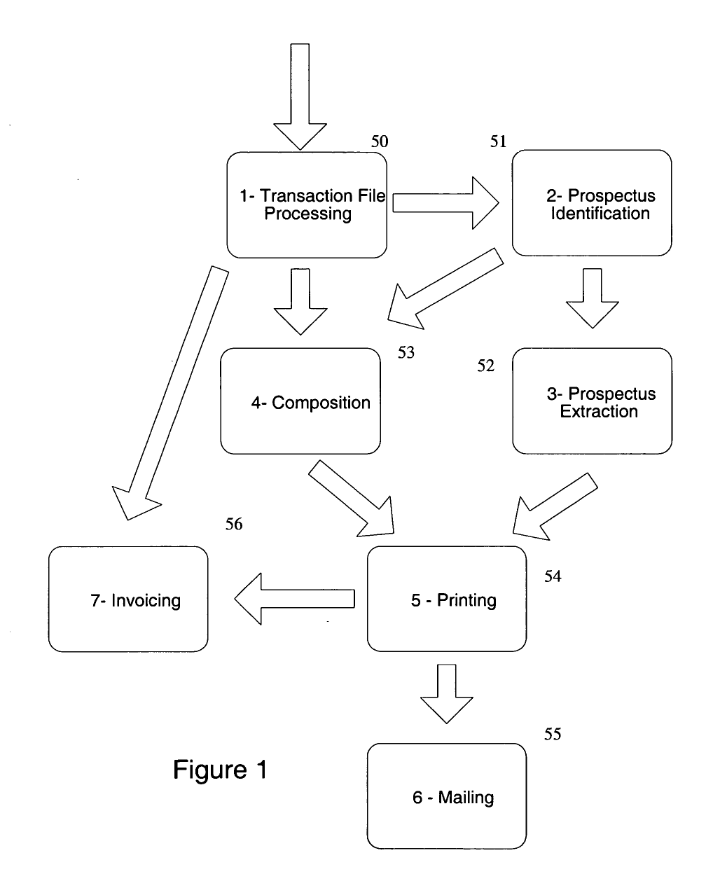

Referring now to FIG. 1, there is shown a functional flowchart illustrating one embodiment of the method of document generation, printing, and mailing according to the present invention. In this embodiment, the method starts at step 50 with the receipt of a trade transaction indication from a brokerage firm or investment dealer. At step 51, the transaction indication received in step 50 is then analysed to determine which simplified prospectuses, if any, are required. If it is determined in step 51 that a simplified prospectus is required, the system proceeds to select the parts of prospectuses in step 52 and to initialize a composition request in step 53. Composition request step 53 preferably generates a custom cover letter and trade confirmation, and provides markers in the electronic documents indicating where the required Part As and Part Bs are to be inserted. Prospectus extraction request step 52 requests the prospectus associated with a purchased fund, and obtains the Part A and Part B(s), as required. If multiple Part As or Part Bs are required for the transaction, then multiple parts are extracted in step 52. If the investor has previously purchased the same fund under the current simplified prospectus with no interim amendments, no prospectus request need be generated at step 52 and the system does not retransmit earlier transmitted documents. After the required extractions, the extracted Part As and Part Bs are printed along with the composition of custom cover letter and trade confirmation in step 54. In step 55, extractions and custom cover letter are all mailed to the investor. According to the embodiment of FIG. 1, after completion of printing, the system can also produce invoices for dealers in step 56 based on the transaction in files received in step 50 and the resulting printing in step 54.

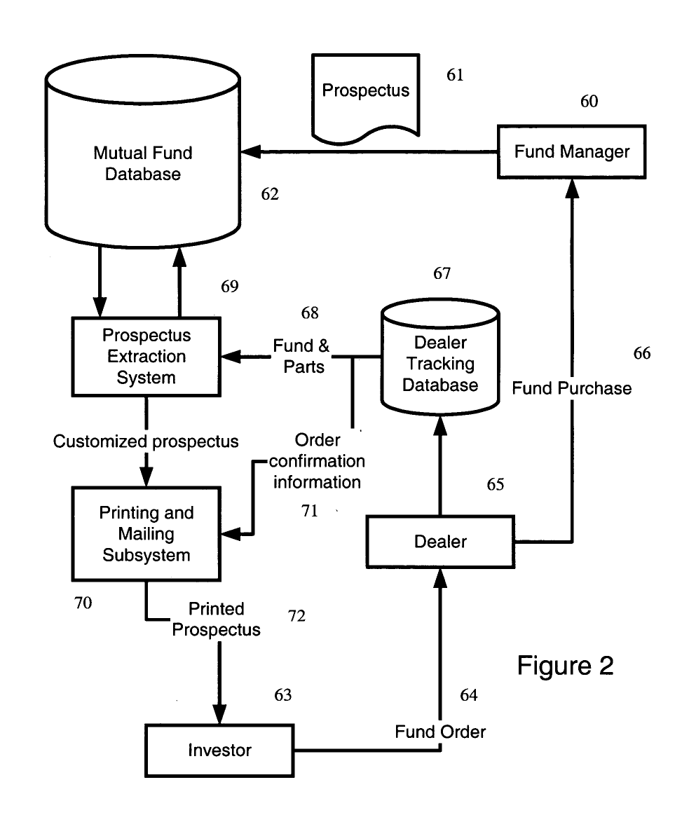

FIG. 2 illustrates one embodiment of the system according to the present invention. By way of background and illustration, this embodiment involves a mutual fund manager that manages a mutual fund, a dealer (such as a brokerage firm) that trades in securities, and an investor interested in purchasing mutual funds managed by the fund manager and sold by the dealer.

As shown in FIG. 2, mutual fund manager 60 files simplified prospectus 61. Simplified prospectus 61 becomes a part of regulatory mutual fund database 62 made available to others, including the operator of the system of the present invention. Investor 63 places fund order 64 with dealer 65. Dealer 65 relays fund order 64 to fund manager 60 as fund purchase 66. Fund order 64 is also provided by dealer 65 to dealer tracking database 67. Dealer tracking database 67 preferably contains information about its investors' accounts, including the account of investor 63. In response to receipt of fund order 64, dealer tracking database 67 is updated to reflect the transaction embodied in fund order 64 for investor 63.

In this embodiment, dealer tracking database 67 operates to determine which portions of simplified prospectus 61, if any, are required to be provided to investor 63 based on this fund order 64, and provides fund and parts information 68 to prospectus extraction system 69. Prospectus extraction system 69 requests the relevant portions of simplified prospectus 61 from mutual fund database 62 and extracts the needed Part A and Part B(s). The Parts extracted by prospectus extraction system 69 are provided to printing and mailing subsystem 70. Print and mailing subsystem 70 also receives order confirmation information 71 generated by dealer tracking database 67. Printing and mailing subsystem 70 generates and prints a cover letter explaining the contents of the package, preferably prints a trade confirmation, as well as the relevant Part A and Part B(s). Printed package 72 generated by printing and mailing subsystem 70 is then sent to investor 63. In an alternate embodiment, printing and mailing subsystem 70 electronically prepares an electronic printed package 72 and then electronically transmits the prepared document to investor 63. Such electronic transmission may include, for example, sending the documents by e-mail, attaching the documents to an e-mail, or sending a link to the documents by e-mail.

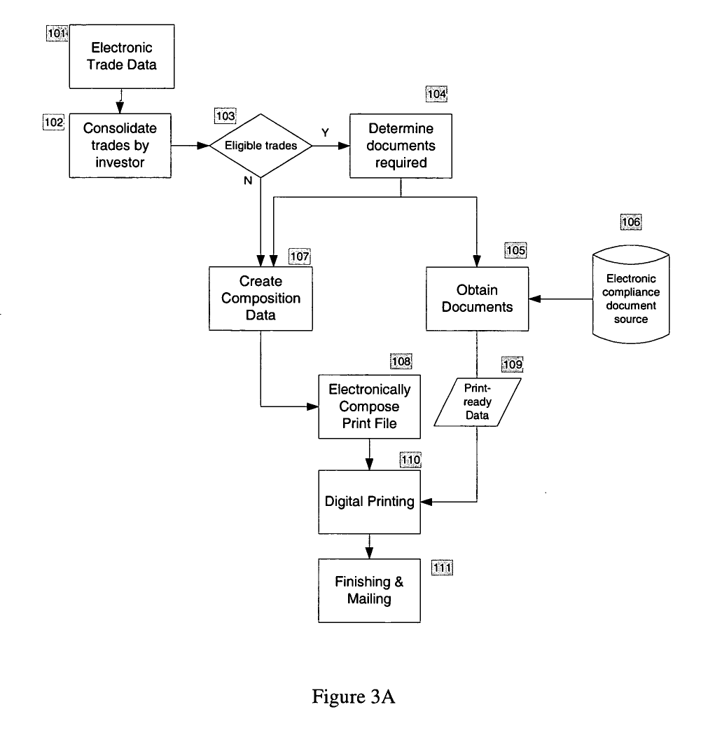

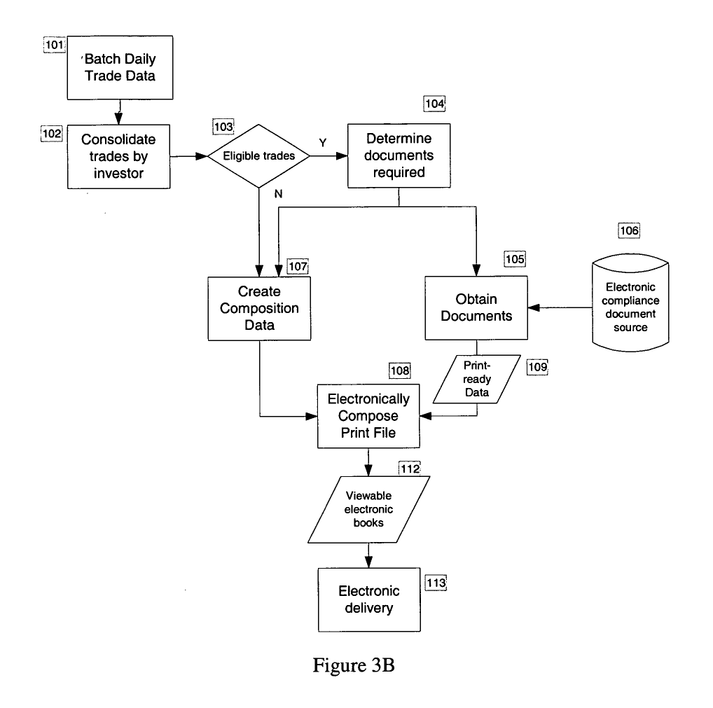

Referring now to FIG. 3A, there is shown a block diagram of one embodiment of the overall system according to the present invention used to automatically generate personalized documents. The diagram of FIG. 3A describes the processes of producing automated, on-demand, custom compliance documents for investors. At step 101, trade data is provided electronically from brokerages, banks, back office providers, or other financial institutions or their agents. In step 102, all trades for a specific investor are grouped together. This grouping is accomplished through the unique account identifier provided in the trade data. The unique account identifier allows multiple documents destined for the same address to be combined into a single mailing, as is more fully described herein. The unique account identifier also forms a link between the trades in the current trade data received in step 101 and any previous mailing made (documents provided) to the investor, as is also further described herein. The tracking of previous mailings made to the investor allows certain documents to be suppressed from being provided to the investor a second time, thereby reducing the volume of the documents and the costs associated with printing and mailing of the same.

After trades are consolidated according to investor in step 102, the system determines eligible trades at step 103. Only certain types of trades may require the provision of compliance documents to the investor. Trades that could require such compliance documents to be provided are referred herein to as “eligible trades”. In the case of a mutual find prospectus, for example, eligible trades comprise any mutual fund buy-type transaction, such as buy, switch into, etc. Other transactions, such as sells, adjustments, or, in some cases, monthly authorized contributions, do not require provision of a prospectus or other compliance information, and are, therefore, not eligible trades.

If, at step 103, the system determines that the investor does not have any eligible trades, no compliance documents are required. However, composed documents, such as trade confirmations, may still be required or desired to be provided to the investor. Thus, in the event it is determined at step 103 that no compliance documents are required, the system proceeds to step 107 where composition data is created. The function of the system at step 107 is more fully described below.

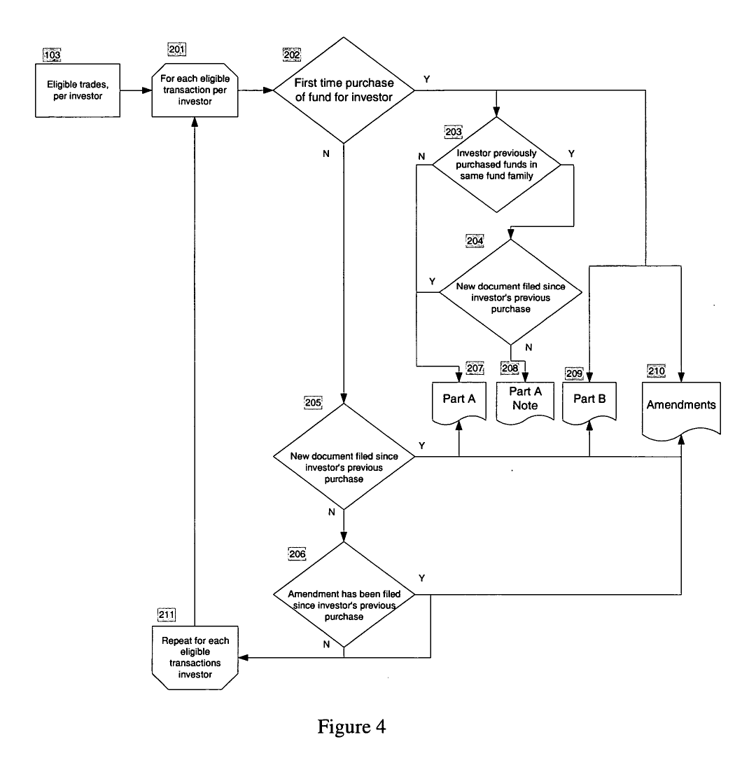

If, at system 103, the system determines that the investor does have eligible trades, the system proceeds to step 104. At step 104, based on the investor's eligible transactions, the system determines the compliance documents required for that investor. One embodiment of the logic used in the determination of compliance documents is described later herein in association with FIG. 4.

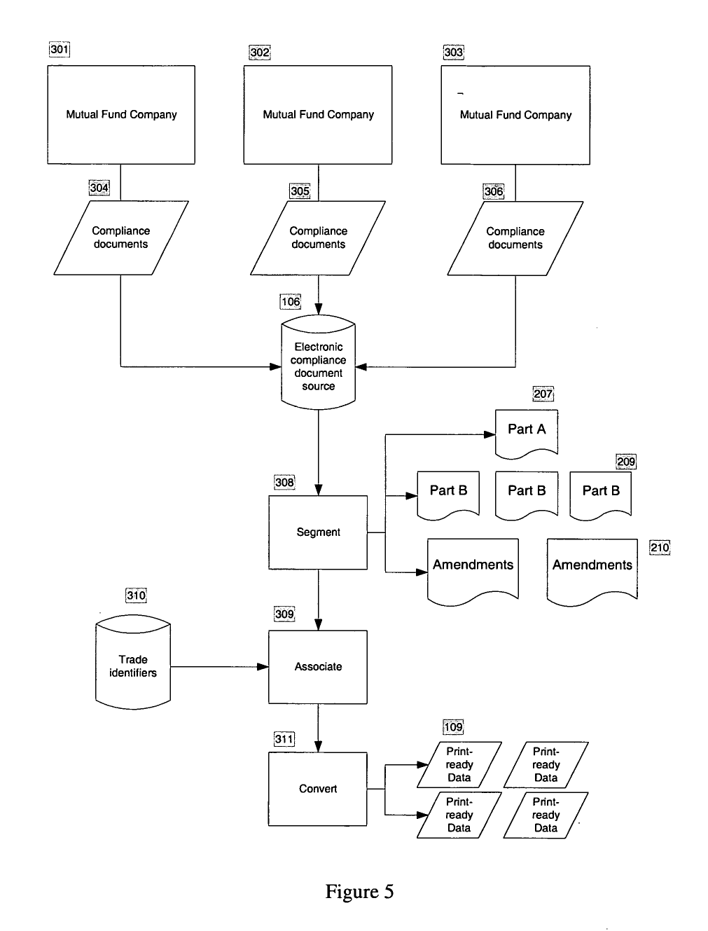

Once the required documents are determined in step 104, the system proceeds to create composition data at step 107 and to obtain documents at step 105 from electronic compliance document source 106. Electronic source 106 may include, for example, in Canada, the service known as the System for Electronic Document Analysis and Retrieval (SEDAR) operated by the Canadian Depository for Securities, or, in the United States, the service known as EDGAR operated by the Securities and Exchange Commission. The provision of the compliance documents denoted in step 105 is described in greater detail herein in association with FIG. 5.

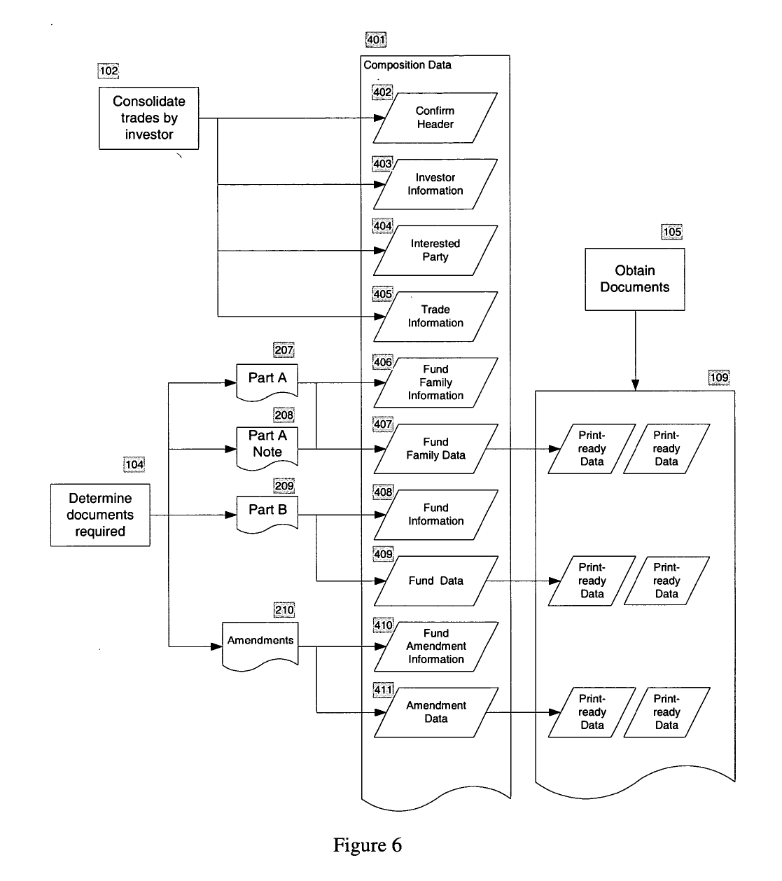

As explained above, regardless of whether the investor has an eligible trade, it is desired to determine composition data if composition documents are required for the investor. At step 107, based on trade data from step 101 and compliance documents, if any, determined at step 104, an electronic composition file is created by the system. The electronic composition file contains all the data required for printing the documents for each investor, logically grouped by physical books to be printed. Use of this composition file minimizes the number of mailings, by grouping all investor documents together, and the number of pages printed, by only including the required documents and transaction data. One embodiment of the process of creation of the composition file denoted as step 107 is more fully described in association with FIG. 6.

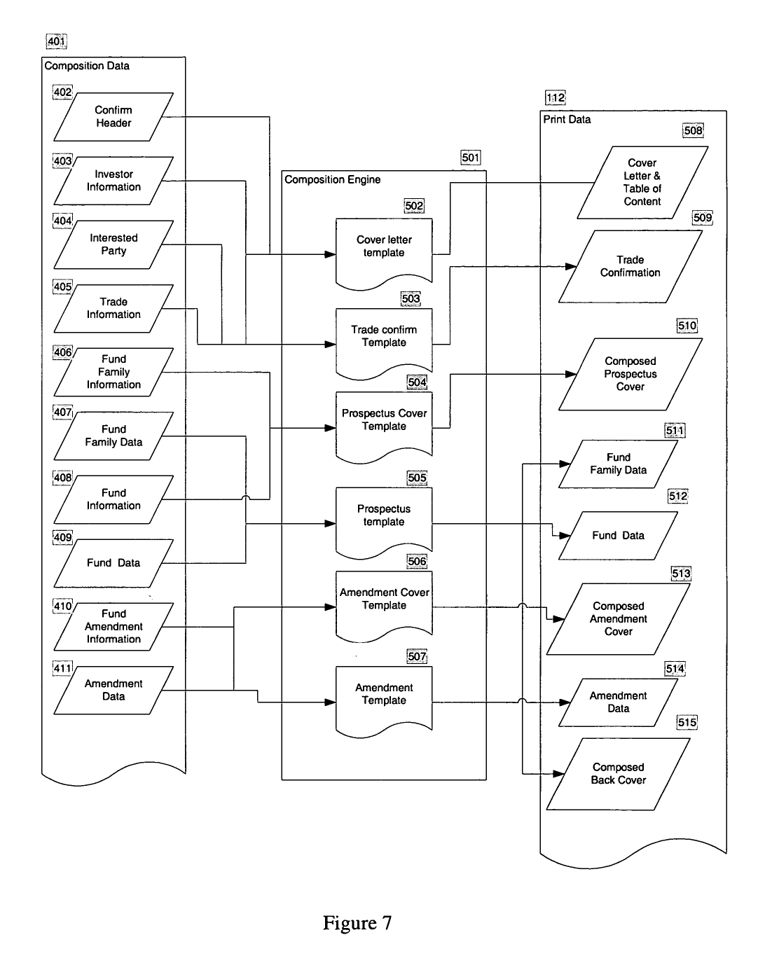

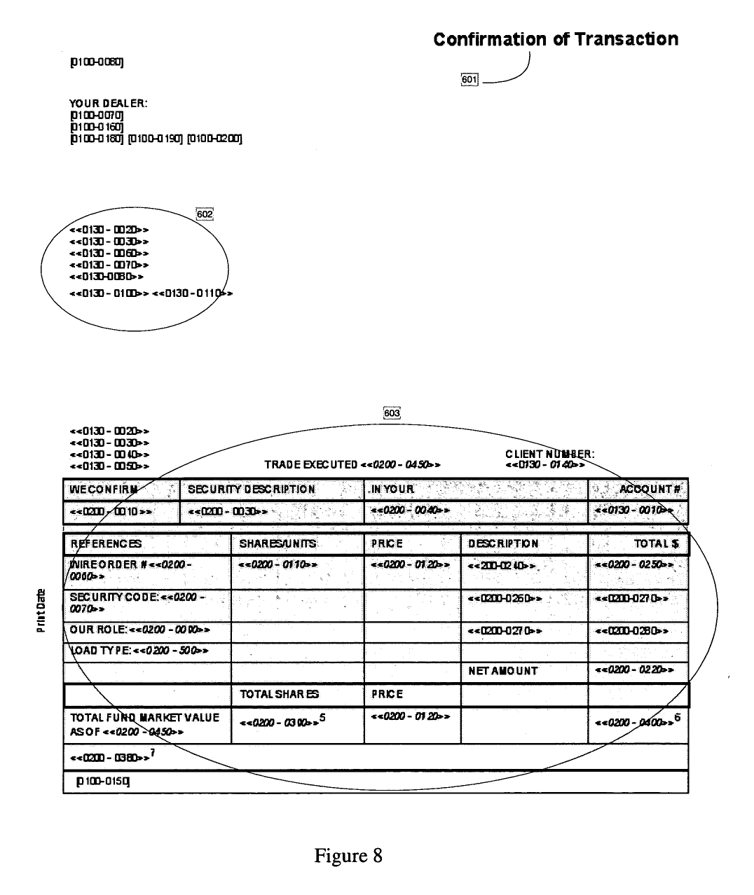

At step 108, a print file is electronically composed based on the composition data generated in step 107. In one embodiment, the print file comprises a graphical print file having the data placed thereon in the correct physical position on a page for composed pages. The composition of a print file in step 108 is done without manual intervention using pre-designed templates that populate the composition data in the correct locations. FIG. 7 further illustrates the composition of a print file, and FIG. 8 illustrates an example of a trade confirmation template. Each of FIGS. 7 and 8 are discussed later herein.

Non-composed pages, such as those obtained from electronic compliance document source 106 comprise print-ready data 109. The documents of electronic compliance document source 106 are generally images of the pages of compliance documents that can be inserted into the printing process of the present invention without modification. In one embodiment, Tag Image File Format (“TIFF”) is used for print-ready data 109. One embodiment of the process of producing the print-ready data 109 is documented in FIG. 5 hereof.

At step 110, the system of the present invention uses digital printing technology to print books of different sizes and compositions. Digital printers combine the composed print file created in step 108 with print-ready data 109 into a single stream of printed book. After step 110 is completed, books are finished (placed in envelopes, poly-wrapped, or shrink-wrapped, for example), and mailed by normal postal processes in step 111. Note that no manual inserts are required to be included in the books prior to step 111, for the books printed in step 110 are final and complete.

FIG. 3B shows a block diagram of another embodiment of the system according to the present invention having an electronic delivery subsystem. The system illustrated in FIG. 3B is an alternate embodiment to that illustrated in FIG. 3A and differs from the system of FIG. 3A in providing a process for producing custom electronic compliance documents in an automated fashion. In the embodiment of FIG. 3B, print-ready data 109 is required for the composition of the electronic print file in step 108, because all documentation is to be provided electronically rather than in paper form. Thus, the system of FIG. 3B does not require the steps 110 and 111 of printing, finishing, and mailing as was required in the system of FIG. 3A. Instead, the print files created in step 108 for each investor are, in step 112, used to create books in electronic format to be viewed by investors. Such viewable electronic books may be created in step 112 in Adobe's Portable Document Form (“PDF”), for example.

The electronic viewable books created in step 112 are delivered to the appropriate investors in step 113. Several methods well known in the art may be used for such delivery, including but not limited to provision as a e-mail, attached to an e-mail, or accessible from a link provided by e-mail to the investor.

Referring now to FIG. 4, there is shown a block diagram of one embodiment of the process of electronic assembly of custom documents according to the present invention. This diagram further describes step 104 of FIGS. 3A and 3B, and generally describes how individual compliance documents are determined to be included in an investor's book. The determination is made based on rules established by the any and all governing or regulating bodies. For mutual funds, for example, mutual fund prospectuses can be divided into two Parts. Part A of a prospectus contains information common to several funds in the same fund family. A Part A can contain several sections. Part B of a prospectus contains information for a specific mutual fund. Often, a prospectus will contain as many Part Bs as the there are funds in the mutual fund family. In addition, after a mutual fund prospectus has been filed, amendments may be filed. Such amendments should be provided to an investor for transactions occurring after such filing. If an investor has previously received a Part A for a fund family, i.e., if the investor has previously purchased a fund from the family of funds, only a Part A Note need be sent to the investor reminding the investor that the previously received Part A applies to the new purchase. Thus, in the exemplary case of a mutual fund, the compliance documents that may need to be provided to the investor are Part A 207, Part A Note 208, at least one Part B 209, and Amendment 210.

In the embodiment illustrated in FIG. 4, the output is arranged hierarchically by investor fund, family, and individual fund. Specifically:
Investor
   Fund Family—one Part A (207) or Part A Note (208)
      Funds—several Part B (209), belonging to the same fund family Amendments (210), if filed for a fund for which a Part B was included
   Fund Family—one Part A (207) or Part A Note (208)
      Funds—several Part B (209), belonging to the same fund family Amendments (210), if filed for a fund for which a Part B was included
Investor

As discussed in association with FIG. 3A and FIG. 3B, the system of the present invention determines eligible trades per investor in step 103. Then, the system proceeds to determine, for each trade for that investor, which compliance documents must be sent to the investor. Hence steps 201 and 211 illustrate the need to perform the analysis for each eligible transaction.

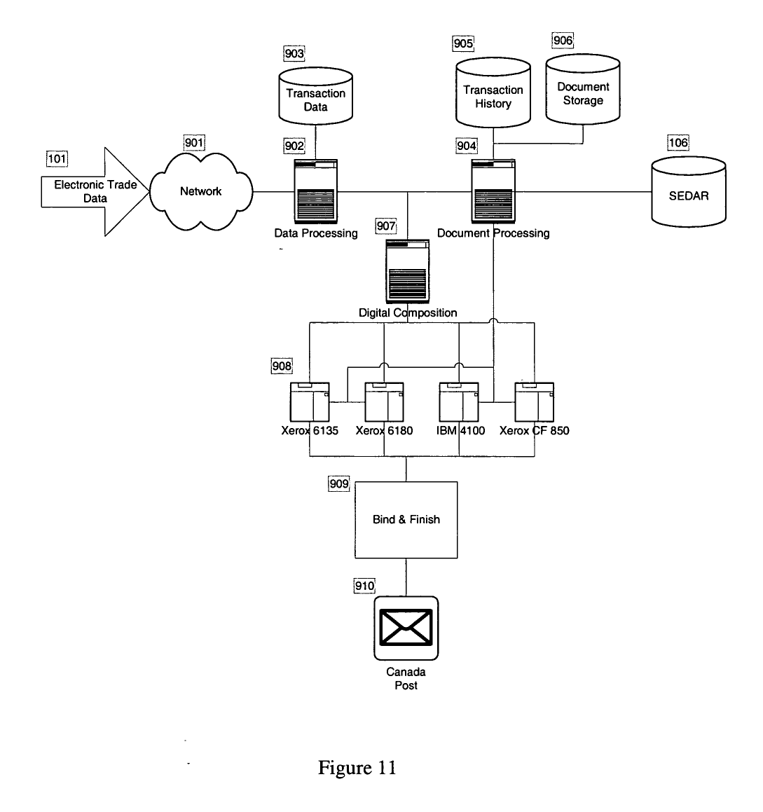

For an eligible trade, the system proceeds to step 202 to determine if the investor is a first time purchaser of the particular fund being traded. This determination is made in step 202 by comparing the current trade to previous trade(s) made by the investor. The information about the investor's past trades or transactions may be determined by accessing dealer tracking database 67 (See FIG. 2) or transaction history database 905 (See FIG. 11), for example. Generally, if the investor has never previously purchased the particular fund, then Part B is required, and any Amendments 210 filed for this fund are also required. Other checks are required to determine if Part A 207 or Part A Note 208 is also required. If the investor has previously purchased the particular fund, then some documents may still be required, depending upon the timing of the previous purchase(s), and any changes to any of the compliance documents.

If it is determined at step 202 that this is an investor's first time purchase of the fund, at step 203 the system examines previous purchases to determine if the investor had previously bought funds from the same fund family as the family to which the current fund belongs. If the system determines at step 203 that the investor has never previously purchased a fund from the same find family, the system records that Part A 207 is required for this transaction.

If the system determines at step 203 that the investor has previously purchased a fund from the same fund family, the system proceeds to step 204. If, at step 204, the system determines that no new document has been filed since that previous purchase, Part A Note 208, instead of Part A 207 is recorded by the system as required. However, if, at step 204, the system determines that a new document has been filed since the previous purchase, then Part A 207 is recorded by the system as required.

Regardless of whether the investor previously purchased a find from the same fund family, Part B 209 and Amendments 210 (if any) are required. Hence, if this is a first time purchase of a fund for an investor as determined at step 202, the system records that Part B 209 and Amendments 210 are required.

If it is determined at step 202 that the investor is not a first time purchaser of the particular find, the system proceeds to step 205. At step 205, it is determined whether a new document (Part A and/or Part B) has been filed for that fund since the investor's previous purchase. If it is determined at step 205 that no new document has been filed, the system proceeds to step 206 where the system determines if an Amendment has been filed since the investor's previous purchase. Generally, if an investor has previously purchased the same fund as the fund in the current trade, and no new document has been filed, but an Amendment has been filed since the previous purchase, then the filed Amendment must be sent. Thus, if no Amendment has been filed as determined in step 206, the system returns to step 211 to perform the analysis for the next fund, if any, included in the transaction being examined.

If it is determined at step 205 that a new document has been filed, the system identifies which of Part A 207, Part B 209, or Amendment 210 has been filed and records that information. If it is determined at step 206 that an Amendment has been filed, the system records that information. Then, the system continues step 211 to repeat the analysis for each eligible transaction.

The loop illustrated in FIG. 4 and bounded by steps 201 and 211 must be repeated for each trade for an investor, and for each investor, to determine the documents required for each investor and for all investors. It is important to note that the present invention can be used for other types of compliance documents. The process illustrated in FIG. 4 would be modified to reflect the composition, business, and legal rules for provision of those compliance documents.

It will be appreciated by those of skill in the art that the process of FIG. 4 reflects the rules applicable to eligible trades in mutual funds. Because the present invention is applicable to the provision of compliance information for other types of transactions, such as share purchase, the process of FIG. 4 would need to be modified to reflect the rules for such other types of transactions.

It will be further appreciated that the determination of compliance documents based on past transactions of the investor may be accomplished using data other than data comprising a log of the investor's past transactions. In one alternative embodiment, past transactions of the investor are determined by examining the investor's account position data. Such account position data is usually maintained by a security holder and/or its dealer and identifies the current accounts held by the investor. The current accounts data usually includes the date of the holdings an identifier for each security held, and the quantity of the security held.

In another alternative embodiment, the determination of required compliance documents can be based on a history of compliance documents previously provided to the investor and the dates so provided. From examination of the past compliance documents provided and the date(s) provided, a processor can infer the new documents to be sent to the investor. The use of a data source comprising data representing the past transactions, account positions, and past compliance documents provided are all contemplated to be within the scope of the invention. Further, the term “past transaction” as used in the claims is intended to include all three embodiments and any equivalents thereto. FIG. 5 shows a block diagram of one embodiment of the process of obtaining compliance documents according to the present invention. This diagram describes both the loading of compliance documents into electronic compliance document source 109 accessible by the system of the present invention, as well as the process of collecting and storing print-ready data 109 by the system of the present invention.

External to the system and method of the present invention, compliance document source 109 is populated by the holder of the securities. Illustrated in FIG. 5 is the publication of an official repository, such as SEDAR or EDGAR, as compliance document source 109. In this embodiment, first, second, and third mutual fund companies 301, 302, and 303, respectively, place first set of compliance documents 304, second set of compliance documents 305, and third set of compliance documents 306, respectively, on document source 106. The documents of first, second, and third sets of compliance documents 304, 305, and 306 comprise prospectuses, amendments, annual reports, and other documents required by the regulator or operator of the official repository.

Steps 308, 309, and 311 of FIG. 5 comprise step 106, the step of obtaining compliance documents, illustrated in FIG. 3A and FIG. 3B. At step 308, the system segments compliance documents retrieved by the system from document source 106. This segmentation is into the different “parts”. For example, a mutual fund prospectus is segmented in two parts: Part A 207 containing the information common to several funds in the same fund family, and Part Bs 208 containing information for a specific mutual fund within the family. A file constituting an amendment can also be segmented into Amendments 210.

At step 309, each document part identified by segmentation step 308 is associated with an identifier used in the daily transactions. To perform this function, trade identifiers database 310 is accessed by the system. Trade identifiers database 310 may be maintained by the operator of the system of the present invention or by a third party. For example, in Canada, FundSERV codes are typically used to identify mutual funds in transactions, while the CUSIP identifying system is used for other securities. Alternately, a data repository comprising a numbering scheme for identity of a type or types of securities may be used and made available for access by the system of the present invention.

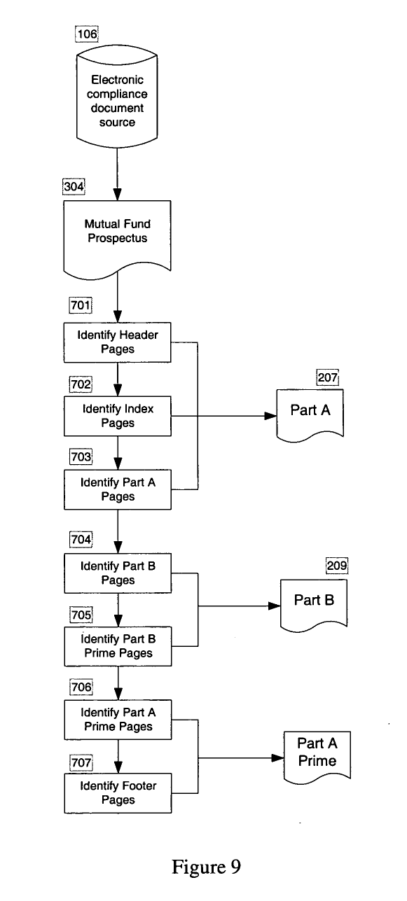

The process disclosed in U.S. Pat. No. 6,122,635 is used to map an identifier with a document. To accomplish the mapping required according to the present invention with segments of documents, a process similar to that disclosed in U.S. Pat. No. 6,122,635 is used. The segmentation process is discussed in greater detail in connection with FIG. 9 hereof.

After trade identifiers from database 310 have been used in step 309 to associate trade identifiers with the trades being examined by the system, the system proceeds to step 311. At step 311, each document part is converted to print-ready data 109. This conversion could include document re-sizing, color correction, and conversion to an image file format, for example. In one embodiment, the documents are reduced to ninety-five percent (95%) of original size, corrected for grey-scale printing, and converted to a TIFF file format.

Referring now to FIG. 6, there is shown a block diagram of one embodiment of electronically preparing composition data to print only the custom documents required according to the present invention. According to the present invention, composition data created in step 107 (see FIG. 3A and FIG. 3B) combines all the required types of information for printing customized, on-demand books for investors. The composition data drives the creation of a digital print file (see step 108 in FIG. 3A and FIG. 3B) used to produced the printed books.

As shown in FIG. 3A and FIG. 3B, trades are consolidated by investor in step 102, eligible trades are determined in step 103, and the documents required are determined in step 104. Composition data 401 consists of multiple elements representing the data needed to compose dynamic content and references to print-read data 109. In this embodiment, composition data 401 includes confirm header data 402, investor information 403, interested party information 404, trade information 405, fund family information 406, fund family data 407, fund information 408, fund data 409, fund amendment information 410, and amendment data 411.

Confirm header data 402 comprises summary information about all trades made by an investor. Confirm header data 402 is aggregated from trade data consolidated in step 102 (see FIGS. 3A and 3B). Confirm header data 402 drives cover letter template 502 (see FIG. 7) to produce printed cover letter and table of content 508 (see FIG. 7).

Investor information 403 comprises all required information for an investor based on trade data received in step 102. Investor information 403 drives cover letter template 502 (see FIG. 7) and trade confirm template 503 (see FIG. 7) to produce printed cover letter and table of contents 508 (see FIG. 7) and trade confirmation 509 (see FIG. 7).

According to this embodiment, interested party information 404 comprises all required information for an interested party based on trade data received in step 102. Interested parties, such as accountants or attorneys, could be recipients of duplicates of the books if they act on behalf of an investor. However, unlike investors, interested parties receive only trade confirmations. Thus, interested party information 404 drives trade confirm template 503 (see FIG. 7) to produce printed trade confirmation 509 (see FIG. 7).

Trade information 405, in this embodiment, comprises data about the actual trades performed by the investor. Trade information 405 is obtain from the trade data acquired in step 102, and drive trade confirm template 503 (see FIG. 7) to produce printed trade confirmation 509 (see FIG. 7).

In this embodiment, fund family information 406 includes information about a specific fund family based on a Part A or Part A Note that was identified in step 104 (see FIGS. 3A and 3B). Fund family information 406 drives cover template 504 (see FIG. 7) to produce printed composed prospectus cover 510 (see FIG. 7).

Fund family data 407 is a reference to the relevant print-ready data 109 produced from step 105 (see FIG. 3A and FIG. 3B) for the specified Part A or Part A Note identified in step 104. Fund family data 407 is included in prospectus template 505 (see FIG. 7) to product printed fund family data 511 (see FIG. 7).

According to the embodiment of FIG. 6, fund information 408 includes information about a specific fund based on a Part B that was identified in step 104. Fund information 408 drives prospectus cover template 504 (see FIG. 7) to product printed composed prospectus cover 510 (see FIG. 7).

Fund data 409 comprises a reference to the relevant print-ready data 109 from step 105 for the specified Part B identified in step 104. Fund data 409 is included in prospectus template 505 (see FIG. 7) to product printed fund data 512 (see FIG. 7).

In this embodiment, fund amendment information 410 includes information about a specific fund amendment that was identified by the system in step 104. Fund amendment information 410 drives amendment cover template 506 (see FIG. 7) to product printed composed amendment cover 513 (see FIG. 7).

Fund amendment data 411 includes a reference to the relevant print-ready data 109 produced from step 105 for the specific amendment identified in step 104. Fund amendment data is included in amendment template 507 to produce printed amendment data 514.

FIG. 7 shows a block diagram of one embodiment of the composition process according to the present invention. As shown in FIG. 7, composition data 401 is comprised of various types of data and information as discussed further herein in association with FIG. 6.

FIG. 7 illustrates how composition data 401 is transformed into print data 112. Print data 112 can be sent to a digital printer. In this embodiment, composition engine 501 controls the mapping of composition data 401 into print data 112. Composition engine 401 contains a number of pre-designed templates 502, 503, 504, 505, 506, and 507. Templates 502, 503, 504, 505, 506, and 507 specify the mapping from composition data 401 to print data 112 and were discussed in association with FIG. 6 above.

As shown in FIG. 7, the print data includes cover letter and table of contents 508, trade confirmation 509, composed prospectus cover 510, fund family data 511, fund data 512, composed amendment cover 513, amendment data 514, and composed back cover 515. In this embodiment, this print data is composed by the system according to the electronic trade data retrieved in step 101 and the documents obtained in step 105 from electronic compliance document source 106. It will be appreciated by those of skill in the art that data such as a cover letter, front book cover, or back book cover are secondary documents because they are not required by regulation, but are likely desired to be provided by the fund manager to the investor. As use herein and in the claims, “secondary documents” means documents or data that does not comprise compliance documents or data, and maybe included in the investor information. In addition to cover letter 508 and back cover 515 illustrated in FIG. 7, secondary documents may include artwork, advertisements, trade confirmations, disclaimers, or other forms of communication desired to be provided to the investor.

It will also be appreciated that the secondary documents may be included in the investor information by various mechanisms. As shown in FIG. 7, the secondary documents are composed by the system of the present invention. In another embodiment, the desired secondary documents may reside on electronic document source 106. In yet another embodiment, secondary documents may reside on a separate data source operatively connected to the network for retrieval by the processor of the system. Of course, any combination of these embodiments may co-exist as well.

Referring now to FIG. 8, there is shown shows diagram of a one embodiment of a trade confirmation template according to the present invention. The exemplary trade confirmation template of FIG. 8 comprises static text 601, references to composition file data 602, and physical layout 603. Static text 601 comprises the portions of the template that do not change based on composition file data 401. In this example, because the template is a trade confirmation template, status text 601 includes “Confirmation of Trade”. This “Confirmation of Trade” language is not dependent upon composition file data 401.

References to composition file data 602 comprise data representative of composition data file 401. In this embodiment, bracketed fields (<< >>) represent entries in composition file 401 to be inserted in that position of the template. For example, under the static text “YOUR DEALER”, address information for the dealer from composition data 401 is inserted, and a security code is entered from composition data file 401 after “SECURITY CODE:” under the “REFERENCES” heading.

The template of FIG. 8 further comprises physical layout 603. Physical layout 603 specifies the graphical placement of data on the printed page. In this example, physical layout 603 includes placement of the “Confirmation of Transaction” header, dealer information, address of the investor, and the chart summarizing the transaction.

FIG. 9 shows a block diagram of one embodiment of the document segmentation process according to the present invention. In general, the segmentation of documents into segments is accomplished by reviewing the document and identifying the start and end page for each section (segment) of the document. As discussed above in connection with FIG. 3A, FIG. 3B, and FIG. 5, a compliance document, such as mutual fund prospectus 304, is obtained in step 106 from an electronic compliance document source.

The first step in segmenting mutual fund prospectus 304 is step 701 wherein the header pages of prospectus 304 are identified. Typically a header page consists of a cover page that comprises part of the Part A of prospectus 304. In step 702, the index pages of prospectus 304, typically the table of contents of prospectus 304, are identified. After identification of the index pages in step 702, the system proceeds to step 703 to identify the Part A pages, i.e., the pages discussing investment in mutual funds in general.

The Part B pages, i.e., the pages that discuss investment in a specific mutual fund, are identified in step 704. As previously discussed, there will be one Part B for each mutual fund discussed in prospectus 304. After identification of the Part B pages in step 704, the system proceeds to identify the Part B prime pages in step 705. The Part B prime pages are the pages of prospectus 304 that discuss investment in specific mutual funds and are physically separated from the initial discussion for the particular fund. For example, a mutual fund prospectus 304 may discuss the financial aspect of each mutual fund in one section of prospectus 304 and then discuss the risks associated with each fund later in prospectus 304. For a given mutual fund, the relevant pages from the financial sections constitute a Part B and the relevant pages from the risk section would constitute a Part B Prime. Part B Prime pages are a part of the Part B of prospectus 304.

As was done for Part B in step 705, the Part A prime pages are identified by the system in step 706. Finally, in step 707, the footer pages of prospectus 304 are identified by the system. Footer pages are general pages that end prospectus 304, including the back cover of prospectus 304.

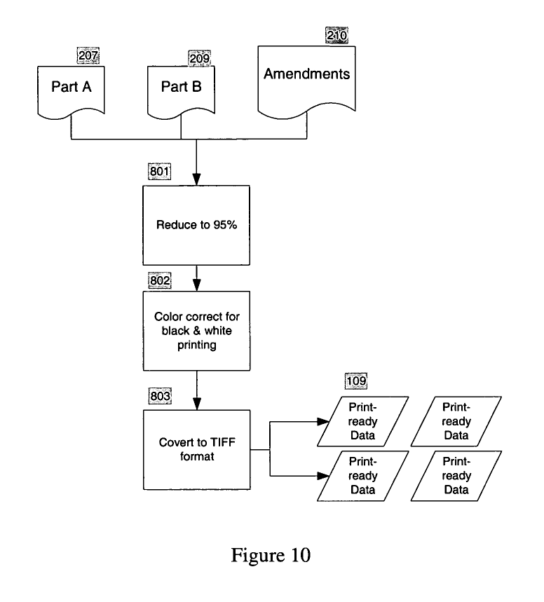

Referring now to FIG. 10, there is shown a block diagram of one embodiment of the document conversion process according to the present invention. Specifically, FIG. 10 illustrates an embodiment of steps involved in step 311 of FIG. 5. At step 801, the necessary Part A 207 (if any), Part Bs 209, and Amendments 210 (if any) are reduced to ninety-five percent (95%) of the original size. This page reduction allows full-page images from the original prospectus to be embedded in a combined document to be provided to the investor, and for that combined document to include a page border and new page numbering, for example. Transformations of compliance information are only valid if authorized and approved by regulatory bodies.

At step 802, the coloring of the original prospectus is adjusted to permit for black and white printing of the combined document. Then, at step 802, each page of the reduced, color adjusted compliance documents to be included in the combined document is converted to a standard TIFF file. Thus, in this embodiment, print ready files 109 have been reduced and color-adjusted, and are in TIFF format.

FIG. 11 shows a block diagram of one embodiment of the system of the present invention. In this embodiment, the system includes network 901. Network 901 is an electronic network used to transfer electronic trade data as collected in step 101 (see FIG. 3A and FIG. 3B). Also connected to network 901 is electronic compliance document source 106, shown in this embodiment as SEDAR used in Canada. Trade identifier database 310 (not shown), discussed above in connection with FIG. 5, may also be connected to network 901.

In general, network 901 is a network permitting bidirectional communication thereon. Network 901 may comprise a local area network, wide area network, a global communications network such as the Internet, a proprietary network, a virtual private network, or any combination thereof, as is well known in the art. Network 901 may also comprise wired, wireless (radio frequency and satellite, for example), optic, or other communications mechanisms, or any combination thereof, as is well known in the art. Various protocols are used for communication over network 901, including but not limited to private protocols, file transfer protocol (FTP), and Connect-:Direct®, provided by Sterling Commerce.

In the embodiment of FIG. 10, three processors are also connected to network 901. These processors include data processing processor 902, document processing processor 904, and digital composition processor 907. Data processing processor 902 is used to consolidate trades by investors (step 102 of FIG. 3A and FIG. 3B), to determine eligible trades (step 103 of FIG. 3A and FIG. 3B), and create composition data (step 107 of FIGS. 3A, 3B, and FIG. 6). In one embodiment, logic is implemented on data processing processor 902 in Java code running on a Sun Solaris central processing unit (“CPU”) available from Sun Microsystems.

To perform its functions, data processing processor 902 is in communication with transaction data database 903. Transaction data database contains all the data received and processed by data processing processor 902. In one embodiment, transaction data database 903 resides on a Sun Solaris CPU using an Oracle 8i database management system available from Oracle Corporation, and is bidirectional communication with data processing database 902 via shared memory or network communication.

Document processing processor 904 is used to determine the documents required (step 104 of FIGS. 3A, 3B, and 4) and obtain these documents (step 105 of FIG. 3A, FIG. 3B, and FIG. 5). In one embodiment, document processing processor 904 comprises a DELL 6400 server from Dell Corporation running the Windows 2000 Server operating system available from Microsoft Corporation.

In the embodiment of FIG. 10, document processing processor 904 is in communication with transaction history database 905 and document storage database 906. Transaction history database 905 is a history database that contains previous trades to determine is documents are required according to step 104 (see FIGS. 3A, 3B, and 4). Document storage database 906 comprises a database of compliance document that have been segmented according to step 308 (see FIG. 5), associated according to step 309 (see FIG. 5), and converted according to step 311 (see FIG. 5) to print-ready format 109. In one embodiment, transaction history database 905 resides on a separate processor using a database management system, document storage database 906 resides on a processor using a database management system, and transaction history database 905 and document storage database 906 are in bidirectional communication with document processing processor 904.

Digital composition processor 907, in one embodiment, comprises a computer running the Dialogue engine available from Exstream Software. Digital composition processor 907, in the embodiment of FIG. 10, is used to compose the print file (step 108). For printing, digital composition processor 907 is in communication with printers 908. In this embodiment, printers 908 comprise high-speed digital printers for printing TIFF files onto paper according to step 110. Examples of high-speed printers include the Xerox 6135 and Xerox 6180 printers available from Xerox Corporation, and the IBM 4100 and IBM CF 850 printers available from International Business Machines Corporation.

Once documents are printed for investors, it is preferred that the documents be bound and finished. Thus, binder and finisher 909 is shown in FIG. 10. Two types of binding are generally used. One referred to as saddle-stitching for books under eighty-eight impressions. For larger books, perfect-binding is used. Bindery equipment may comprise IBIS Digistitcher, Bourg Stitcher, or Sulby Autobinder. Books are then finished by being stuffed in envelopes, poly-wrapped, or shrink-wrapped. Finishing equipment may comprise Cima-Pak Polly bagger and a Danark Shrink wrapper.

After books are bound and finished into packages, the packages are prepared for mailing and delivered to a postal service. Some packages are sent via couriers, if requested. Mailing equipment 910 may comprise Bowe Bell & Howell 4000, Bowe Bell & Howell VIP-6 station inserter, and an Itellascan Mail verification system, for example.

It will be appreciated by those of skill in the art that any one of these processors 902, 904, or 907 may comprise a server, mainframe, minicomputer, microcomputer, or other processing means, or any combination thereof as is well known in the art. Also, each processor 902, 904, and 907 may be comprised of several processors. Further, processors 902, 904 and 907 may be combined into a single processor.

The present invention helps dealers strengthen their relationships with investors and saves a portion of the costs associated with fulfillment, mailing and inventory management of commercially printed prospectuses by offering electronic delivery, for investors who choose this option, or, otherwise, print-on-demand mail delivery of a document that only contains information on the mutual funds purchased by the investor and combining the trade confirmation delivery with the simplified prospectus delivery.

One skilled in the art will appreciate that the present invention can also operate in a hybridized environment, where compliance information about one group of funds is provided by using the system and/or method of the present invention while compliance information about another group of finds is provided in the conventional manner.

As noted above, although the previous example was mutual fund specific, the present invention can be applied to generate any document or compliance information that must or may be provided to an investor. For example, in the case of share purchases, it is common that the investor is provided the most recent quarterly report, or the annual report, when a security is first purchased. The present invention can be used to determine which most recent report, or reports, are to be provided to the investor, and custom produce a package, including a cover letter, a trade confirmation, and the desired reports. To facilitate an understanding of the application of the system and method of the present invention, three examples are discussed below. These three examples are illustrative and are not intended to be limiting as to the scope of the present invention.

In one example, the present invention is used to enable the delivery of a non-mutual fund prospectus based on trades of securities other than mutual finds. In this embodiment, the prospectus is not segmented (see step 308 of FIG. 5), and compliance documents are sent during the issuing period. More specifically, during the issuing period for the security, the compliance documents are sent to all buyers.

Referring to FIG. 3A, this embodiment differs from that described with regard to mutual funds in that electronic trade data obtained in step 101 comprises trades for securities other than mutual funds, such as stock, bonds, linked notes, etc. In determining eligible trades in step 103, all new issue buys are considered “eligible trades”. In this embodiment, the determination of documents required in step 104 is a simple rule that maps a security identifier to a required compliance document. Electronic compliance document source 106 comprises a database such as EDGAR or SEDAR, as previously described in association with the example using mutual funds.

The logic of FIG. 4 and FIG. 9 do not apply to the provision of required compliance documents for trades in securities other than mutual funds. Instead, the logic is reduced to simply the determination of an eligible trade, because the identification of an eligible trade requires provision of the compliance document. Referring to FIG. 5, companies 301, 302, and 303 comprise any issuer of securities, and compliance documents 304, 305, and 306 comprise the prospectus for this security. In FIG. 6, documents 207, 208, 209, and 210 are replaced with an entire prospectus, and items 406, 407, 408, and 409 of FIG. 7 are replaced with “New Issue Information” and “New Issue Data”.

In another example of the application of the system and method of the present invention, consider the requirement to provide present investors with a mutual fund company's annual and semi-annual reports. In this instance, the compliance documents delivered comprise the annual report or the semi-annual report which are to be provided to holders of the mutual funds as of a particular date, with such date related to the period covered by the annual report or the period covered by the semi-annual report.

Referring to FIG. 3A, the embodiment differs from that of the provision of a prospectus based on a trade in that the electronic trade data retrieved in step 101 comprises an “electronic account position”, and the consolidation of step 102 is performed with regard to consolidation of holdings by investor. Step 103, determination of “eligible trades” is not required in this embodiment. The logic of FIGS. 4 and 9 is modified because every fund owned by an investor will generate Part B 209, an investor will always receive Part A 207, Part A Notes 208 are not used, and Amendments 210 may not be required. In this embodiment, compliance documents 304, 305, and 306 of FIG. 5 comprise the annual report or semi-annual report for the fund held by the investor. Composition data 401 of FIG. 6 does not need to contain interested party information 404 or trade information 405. Also, composition template 501 would differ for this embodiment.

In a third example application of the system and method of the present invention, the present invention is used to delivery welcome kits to new investors. Key to this application is the need to receive the new investor's name and address. The documents desired to be delivered to the new investor may comprise both compliance information and marketing information. Usually, such documents are provided to the investor by the deal, broker, or bank.

Referring to FIG. 3A, the electronic trade data received in step 101 is replaced with new investor account information, the consolidation under step 102 comprises consolidation by investor, and step 103, the determination of eligible trades, is not necessary because the determination is made based on a new investor. In this embodiment, the logic of FIG. 4 differs in that it is based on a specified matrix. This specified matrix maps the new investor account information to the documents required for the kit to be delivered. For example, the mapping could be based on the investor's language preference, the type of account, the line of business which hosts the account, or other mappings specified by the dealer. Based on the value of these fields or fields such as these, the mapping results in a list of required documents. These required documents replace those of 207, 208, 209, and 210 in FIG. 4. If the required documents are provided in print-ready format, the process of FIG. 5 is not required in this embodiment. If not provided in print-ready format, the process of FIG. 5 would be replaced with a process specific to the manipulation required to place the documents provided in print-ready format.

In this embodiment of provision of information to a new investor, the account information consolidated in step 102 of FIG. 6 drives parts of the composition file, while the documents required as determined in step 104 drives the remainder of the parts of the composition file. Similarly, in FIG. 7, composition data 401 drives a series or templates in composition engine 501 to produce print data 112.

One skilled in the art will appreciate that the required reports are typically available in an electronic format from a database similar to those used for mutual funds, though structured in a slightly different manner. This allows for a determination of the applicable documents or compliance information, a database query to obtain the documents or compliance information and then a custom print or electronic document generation followed by delivery to the investor. One skilled in the art will appreciate that, as an added benefit to the investor, analyst reports stored in a database can be provided to the investor regarding a recently purchased security. Though not considered compliance information, it may be desirable to provide the investor the most recent analyst reports for both the purchased security and the industry segment related to the security. One skilled in the art will appreciate that a system similar to the above described system for mutual funds, without need for the determination of relevant Part A's and Part B's, can be employed to provide such a service. Such a system obviates the necessity for a manual selection and packaging process to fulfill the desire or requirement to send investors information.

It will be further appreciated by those of skill in the art that the present invention provides advantages of automation, consolidation, personalization, and on-demand compliance documents. As to automation, the present system of invention operates without required human intervention using available computers and equipment, and the method of the present invention does not require human decisions to be performed. Thus, the system and method of the present invention avoids the costs and errors associated with manual processes, such as the manual pick-and-pack process.

The system and method of the present invention consolidate the several documents required for compliance. This compliance alone reduces the size of the book to be delivered to an investor, and thereby reduces printing and mailing costs.

In addition to the reduction in printing and mailing costs resulting from consolidation, printing and mailing costs are further reduced as a result of the personalization aspect of the present invention. The present invention personalizes the book to be delivered to an investor based on both the present transaction and the investor's history of transactions.

The system and method of the present invention can be utilized to produce the compliance documents required on demand. Thus, inventory is not required to be produced, sorted, stored, and managed. Thus, additional cost savings are incurred in the on demand, “just in time” approach. The receipt of electronic trade data in step 101 by the processor of the present invention may trigger the on-demand creation of the package for the investor and/or third party. Alternately, the system of the present invention may accumulate such electronic trade data for several trades, such as those occurring in a single day, and then trigger the process of creating the package(s) for the investor(s) based on the cumulative received electronic trade data. Also, this triggering can be programmed or require manual instruction, if so desired. Further, the production of package(s) for investor(s) can occur within a prescribed time period, such as a forty-eight hour time period, as prescribed by legal rules (such as regulatory requirements) or business rules (such as is desired by the security holder or its agent).

It will also be appreciated that the present invention is advantageous to investors as well. Investors receiving the output from the present invention are not burdened with unnecessary or repetitive documents. The investor receives only that minimally required by regulatory authorities for the specific transaction.

It will be still further appreciated by those of skill in the art that the present invention is useful to produce investor documents, the contents of which are determined by legal rules and/or business rules. As such, the investor document may comprise compliance information where such “compliance” is either legally driven and/or dictated by business preferences.

As used herein and in the claims, the term “security” means a mutual fund, stocks bonds, or any publicly trade security. Also, the term “source” when used in connection with data means a database or any other repository of data. The above-described embodiments of the present invention are intended to be examples only. Alterations, modifications and variations may be effected to the particular embodiments by those of skill in the art without departing from the scope of the invention, which is defined solely by the claims appended hereto.

1. A system, comprising:
a network;
an electronic document source for storage of at least one investor document, the electronic document source operatively connected to the network;
a history source operatively connected to the network, the history source comprising history data representative of at least one past transaction for at least one investor;
a processor operatively connected to the network, the processor programmed to receive current investment data for an investor,
identify from the history source past transaction(s), if any, for the investor,
identify document(s) applicable to the current investment data received,
determine required investment information for the investor from the identified document(s) applicable to the transaction and based on the past transaction(s) identified, and
retrieve the required investment information from the at least one investor document stored on the electronic document source.

2. The system of claim 1, wherein the processor is further programmed to consolidate the retrieved investment information into a single package per investor.

3. The system of claim 2, wherein the processor is further programmed to compose a secondary document, and wherein the consolidation performed by the processor includes consolidation of the secondary document together with the retrieved investment information.

4. The system of claim 3, wherein the secondary document comprises at least one of the group consisting of a cover page, table of contents, back cover, artwork, advertisement, trade confirmation, or disclaimers.

5. The system of claim 2, wherein the consolidation performed by the processor produces the single package in a desired electronic format.

6. The system of claim 2, wherein the consolidation performed by the processor produces the single package in a desired format for printing a hard copy thereof.

7. The system of claim 6, wherein the processor is further programmed to receive a request for production of the single package, and wherein the production of the single package is performed in response to the request for production.

8. The system of claim 7, wherein the request for production comprises receipt by the processor of the current investment data.

9. The system of claim 7, wherein the production of the single package occurs within a prescribed time period.

10. The system of claim 9, wherein the prescribed time period is established by a legal rule applicable to the current investment data.

11. The system of claim 1, wherein at the at least one investor documents comprises a plurality of parts and each of the plurality of parts is defined with a code, and wherein the processor uses such codes in determination of the required investment information.

12. The system of claim 1, wherein at least one of the at least one investor documents comprises a compliance document.

13. The system of claim 12, wherein the compliance document comprises a simplified prospectus.

14. The system of claim 13, wherein the simplified prospectus comprises a mutual fund simplified prospectus including a Part A and a plurality of Part Bs.

15. The system of claim 14, wherein the identified document(s) comprise one of the plurality of Part Bs.

16. The system of claim 14, wherein the required investment information further comprises one of the Part A or a Part A Note.

17. The system of claim 1, wherein at least one of the at least one investor documents comprises a financial report.

18. The system of claim 17, wherein the financial report consists of one of the group of annual report, semi-annual report, quarterly report, or monthly report.

19. The system of claim 1, wherein at least one of the at least one investor documents comprises a new account disclosure document.

20. The system of claim 1, wherein at least one of the at least one investor documents comprises a secondary document.

21. The system of claim 1, further comprising:
a secondary document source operatively connected to the network, the secondary document source comprising at least one secondary document, and
wherein the processor is further programmed to determine required secondary documents applicable to the transaction and retrieve the required secondary documents from the secondary document source.

22. The system of claim 1, wherein the history data stored on the history source comprises past securities transactions data.

23. The system of claim 1, wherein the history data stored on the history source comprises past investor account holding data.

24. The system of claim 1, wherein the history data stored on the history source comprises past documents sent identification data.

25. The system of claim 1, wherein the current investment data comprises an identifier for the investor and wherein the history data comprises an identifier for the at least one investor, such that the processor uses the identifier for the investor from the current investment data and the identifier for the at least one investor of the history data to identify past transaction(s), if any.

26. The system of claim 1, wherein each of the at least one investor documents stored on the electronic document source comprises one or more codes, and wherein the processor compares the current investment data received to the code(s) of the investor documents in identifying document(s) applicable to the current investment data.

27. The system of claim 26, wherein the processor is further programmed to create a mapping of the current investment data to the code(s) of the investor documents.

28. The system of claim 1, wherein the required investment information comprises a portion of one of the at least one investor documents.

29. The system of claim 1, wherein the determination of the required information performed by the processor is based on at least one legal rule.

30. The system of claim 1, wherein the determination of the required information performed by the processor is based on at least one business rule.

31. The system of claim 1, wherein at least one of the identified document(s) comprises a plurality of parts, and wherein the required investor information determined by the processor comprises at least one of the plurality of parts.

32. The system of claim 31, wherein only the at least one of the plurality of parts of the identified document(s) is (are) retrieved by the processor when retrieving the required investment information.

33. The system of claim 1, wherein the processor is further programmed to convert the retrieved required investment information into a format suitable for printing.

34. A method, comprising the steps of:
providing a network, an electronic document source for storage of at least one investor document, a history source comprising history data representative of at least one past transaction for at least one investor, and a processor, the network, electronic document source, and history source all operatively connected to the network;
receiving at the processor current investment data for an investor;
identifying from the history source past transaction(s), if any, for the investor, the identification of past transaction(s) performed by the processor;
identifying, with the processor, document(s) applicable to the current investment data received;
determining with the processor required investment information for the investor from the identified document(s) applicable to the transaction and based on the past transaction(s) identified; and
with the processor, retrieving the required investment information from the at least one investor document stored on the electronic document source.

35. The method of claim 34, further comprising the step of:
consolidating the retrieved required investment information into a single package.
